(19) United States
(12) Patent Application Publication
(10) Pub. No.: US 2016/0320885 A1
(43) Pub. Date: Nov. 3, 2016

(54) DISPLAY DEVICE WITH TOUCH SENSOR

(71) Applicant: Samsung Display Co., Ltd., Yongin-si (KR)

(72) Inventors: Kyung Seop KIM, Hwaseong-si (KR); Sung Kyun PARK, Suwon-si (KR); Sang Kyu CHOI, Daejeon (KR); Sang Youn HAN, Seoul (KR); Ki-Hyun CHO, Suwon-si (KR); Sun Haeng CHO, Hwaseong-si (KR)

(21) Appl. No.: 14/936,164

(22) Filed: Nov. 9, 2015

(30) Foreign Application Priority Data
Apr. 28, 2015 (KR) 10-2015-0059681

(51) Int. Cl. G06F 3/041

(52) U.S. Cl. CPC G06F 3/0412

(57) ABSTRACT

A display device including a display panel including pixels, and a touch sensor disposed on the display pane. The touch sensor includes a touch substrate, sensing electrodes disposed on the touch substrate, a passivation layer covering the sensing electrodes on the touch substrate and a first low refractive layer disposed between the touch substrate and the passivation layer, and having a refractive index lower than a refractive index of the passivation layer.

### CROSS-REFERENCE TO RELATED APPLICATION

This application claims priority from and the benefit of Korean Patent Application No. 10-2015-0059681, filed on Apr. 28, 2015, which is hereby incorporated by reference for all purposes as if fully set forth herein.

### BACKGROUND

1. Field

Exemplary embodiments relate to a display device. More particularly, exemplary embodiments relate to a display device including a touch sensor and a polarization film.

2. Discussion of the Background

A touch sensor is an input device for a display device (e.g., a smartphone, tablet, and laptop computer). A user may input information on a display device touching a screen with an object (e.g., a finger or a stylus pen) with a touch sensor. Among many types of touch sensors for display devices, a capacitive touch sensor is commonly used. When an object touches a screen of a display device including a capacitive touch sensor, the capacitive touch sensor senses a change in capacitance at a position where the object touches the screen. The chance in capacitance occurs in response to the object touching two electrodes of the touch sensor spaced apart from each other.

Display devices (e.g., smartphones, tablets, and laptops) are currently desired to be thin, convenient, and generate high-resolution images. Thus, flexible display devices have recently be developed. However, a thin flexible display requires a thin and flexible touch sensor.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device including a touch sensor integrated with a polarization film. Exemplary embodiments also provide a display device that prevents damage to a substrate and sensing electrodes when patterning the sensing electrodes. Exemplary embodiments also provide a display device with improved light transmittance emitted from a display panel.

Additional aspects will be set forth in the detailed description which follows, and, in part, will be apparent from the disclosure, or may be learned by practice of the inventive concept.

An exemplary embodiment discloses a display device including a display panel including pixels, and a touch sensor disposed on the display pane. The touch sensor includes a touch substrate, sensing electrodes disposed on the touch substrate, a passivation layer covering the sensing electrodes on the touch substrate and a first low refractive layer disposed between the touch substrate and the passivation layer, and having a refractive index lower than a refractive index of the passivation layer.

An exemplary embodiment also discloses a display device including a display panel including pixels, and a touch sensor integrated polarization film disposed on the display panel. The touch sensor integrated polarization film includes a circular polarizer, sensing electrodes disposed on the circular polarizer, a passivation layer covering the sensing electrodes on the circular polarizer, a first low refractive layer disposed on a lower surface of the passivation layer, the first low refractive layer having a refractive index lower than a refractive index of the passivation layer, a second low refractive layer disposed on an upper surface of the passivation layer, the second low refractive layer having a refractive index lower than the refractive index of the passivation layer, and a linear polarizer disposed on the second low refractive layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a top plan view illustrating a display device according to an exemplary embodiment.

FIG. 2 is a cross-sectional view illustrating the display device taken along sectional line II-II′ of FIG. 1.

FIG. 3 is a cross-sectional view schematically illustrating the display device taken along sectional line III-III′ of FIG. 1.

FIG. 4 is an enlarged cross-sectional view of an organic light emitting diode display according to an exemplary embodiment.

FIG. 5 is an partially enlarged cross-sectional view of the display device taken along sectional line V-V′ of FIG. 1.

FIG. 6 is a cross-sectional view illustrating a display device according to an exemplary embodiment.

FIG. 7 is a cross-sectional view illustrating a display device according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

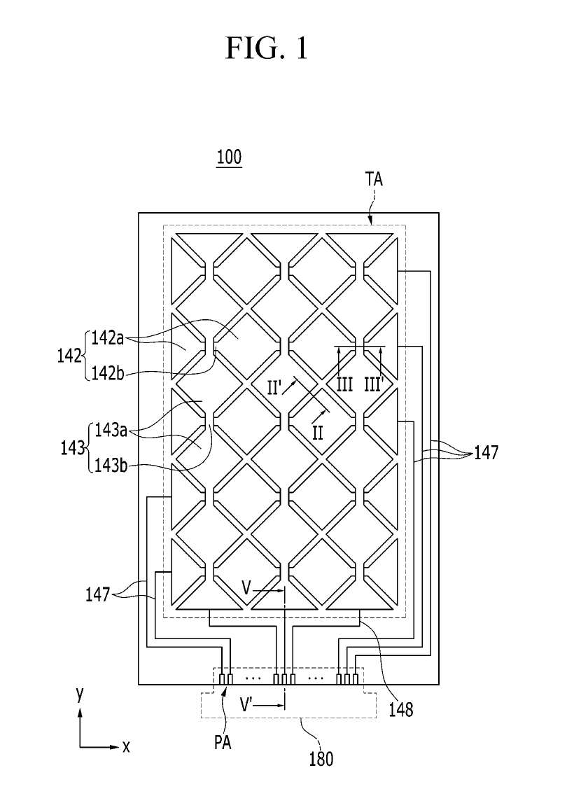

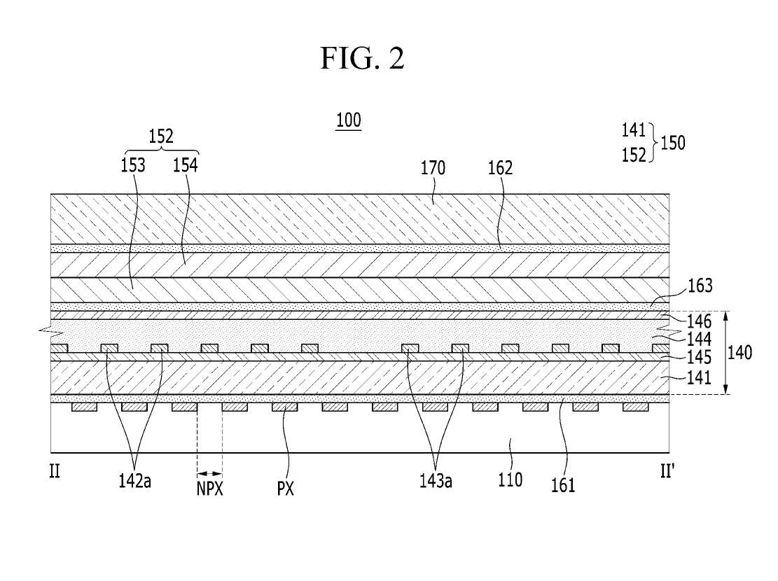

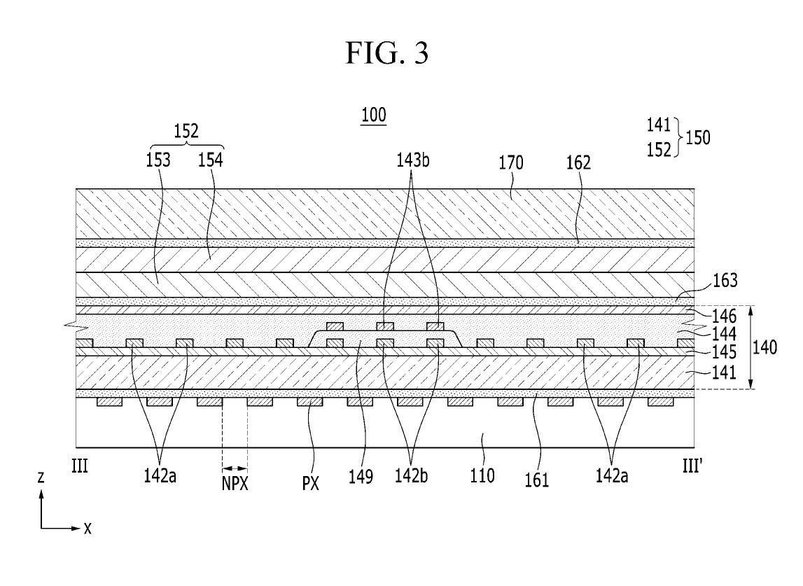

FIG. 1 is a top plan view illustrating a display device according to an exemplary embodiment. FIG. 2 and FIG. 3 are cross-sectional views schematically illustrating the display device taken along sectional lines II-II′ and III-III′ of FIG. 1, respectively.

Referring to FIGS. 1, 2, and 3, a display device 100 may include a display panel 110 displaying an image and a touch sensor 140 formed on the display panel 110. The display device 100 may further include a polarization film 150 that improves visibility of a screen by suppressing reflection of external light.

The polarization film 150 may be integrated with the touch sensor 140 and may include a touch substrate 142. The polarization film may also include a linear polarizer 152 described in detail below. The touch sensor 140 may be attached to the display panel 110 by a first adhesive layer 161.

The display device 100 may further include a second adhesive layer 162 and a cover window 170 formed on the linear polarizer 152 of the polarization film 150. The cover window 170 may protect the polarization film 150, the touch sensor 140, and the display panel 110 from external impact, scratches, and the like.

The display panel 110 may include pixels PX spaced apart from each other. The display panel 110 may display image by combining light emitted from the pixels PX. An area of the display panel 110 between the pixels PX is a non-pixel area NPX that does not emit light. The display panel 110 may include the pixels PX and the non-pixel areas NPX positioned between the pixels PX.

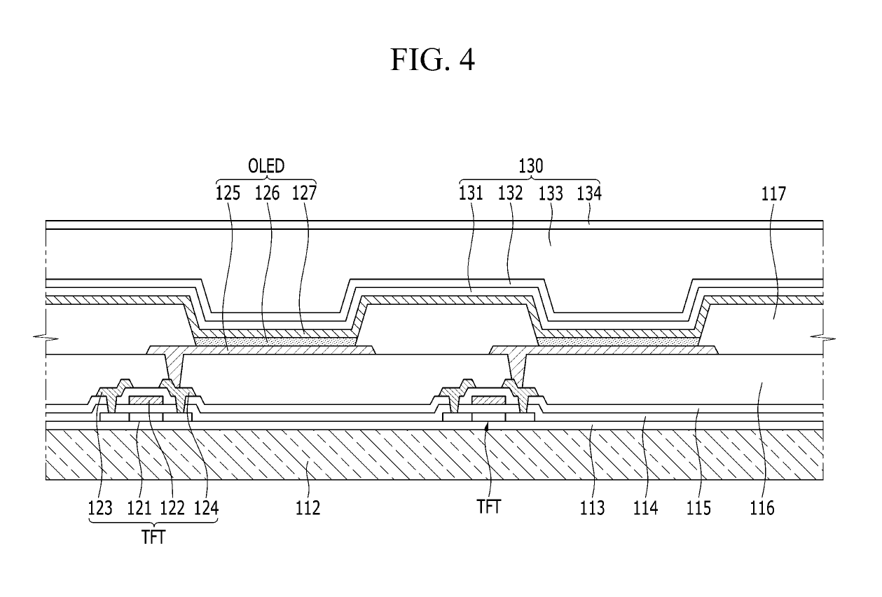

The display panel 110 may be an organic light emitting diode (OLED) display. In the OLED display, each pixel PX may include an OLED and a driving circuit unit controlling a light emission of the OLED. The driving circuit unit may include at least two thin film transistors and at least one capacitor. FIG. 4 is an enlarged cross-sectional view of an OLED display according to an exemplary embodiment.

Referring to FIG. 4, a buffer layer 113 may be formed on a substrate 112 and a semiconductor layer 121 may be formed on the buffer layer 113. The semiconductor layer 121 may include a channel region that is not doped with impurities. The semiconductor layer 121 may also include a source region and a drain region that are positioned at both sides of the channel region and doped with impurities. A gate insulating layer 114 may be formed on the semiconductor layer 121. A gate electrode 122 may be formed on the gate insulating layer 114. The gate electrode 122 may overlap the channel region of the semiconductor layer 121.

An interlayer insulating layer 115 may be formed on the gate electrode 122. A source electrode 123 and a drain electrode 124 may be formed on the interlayer insulating layer 115. The source electrode 123 and the drain electrode 124 may be connected to the source region and the drain region of the semiconductor layer 121 through via holes. The via holes may be formed in the interlayer insulating layer 115 and the gate insulating layer 114. A thin film transistor TFT illustrated in FIG. 4 may be a driving thin film transistor and may be covered with a planarization layer 116.

A pixel electrode 125 may be formed on the planarization layer 116. The pixel electrode 125 may be formed in each pixel one by one and connected to the drain electrode 124 of the driving thin film transistor TFT through a via hole formed in the planarization layer 116.

A pixel defining layer (or a partition wall) 117 may be formed on the planarization layer 116 and the pixel electrode 125. The pixel defining layer 117 may include an opening to expose a central portion of the pixel electrode 125 on which an emission layer 126 is to be positioned.

The emission layer 126 may be formed on the pixel electrode 125 and a common electrode 127 may be formed on the emission layer 126 and the pixel defining layer 117. The common electrode 127 may be formed over the entire display area and may not be differentiated for each pixel. Any one of the pixel electrode 125 and the common electrode 127 may inject holes into the emission layer 126 and the other may inject electrons into the emission layer 126. The electrons and the holes are combined in the emission layer 126 to generate excitons, and photons or light is emitted by energy generated when the excitons drop from an excited state to a ground state.

The pixel electrode 125 may be a reflective layer and the common electrode 127 may be a transparent layer or a translucent layer. Light emitted from the emission layer 126 may be reflected from the pixel electrode 125 and may penetrate the common electrode 127 to be emitted to the outside the OLED through the encapsulation 130 described below.

When the common electrode 127 is formed of the translucent layer, a part of the light reflected from the pixel electrode 125 is re-reflected from the common electrode 127 to form a resonance structure, thereby enhancing light extraction efficiency.

Because an OLED is highly vulnerable to moisture and oxygen, an encapsulation 130 seals the OLED to prevent the permeation of external moisture and oxygen. The encapsulation 130 may be configured of a multilayer of an inorganic layer and an organic layer. For example, the encapsulation 130 may include a capping layer 131, a first inorganic layer 132, an organic layer 133, and a second inorganic layer 134 which are sequentially stacked on the common electrode 127.

The capping layer 131 may include lithium fluoride LiF, and the first inorganic layer 132 and the second inorganic layer 134 may include any one of aluminum oxide (AlOₓ), silicon nitride (SiNₓ) and silicon oxide (SiO₂). The organic layer 133 may include any one of epoxy, acrylate, and urethane acrylate. The encapsulation 130 may be very thin and is suitable for a flexible display device

Referring back to FIG. 1, FIG. 2, and FIG. 3, the touch sensor 140 may include a touch substrate 141 having a polarization function, sensing electrodes 142 and 143 formed on the touch substrate 141, a passivation layer 144 covering the sensing electrodes 142 and 143, and a first low refractive layer 145 formed on a lower surface of the passivation layer 144. The touch sensor 140 may further include a second low refractive layer 146 formed on an upper surface of the passivation layer 144.

The touch substrate 141 may be a circular polarizer (¼ wavelength plate or λ/4 retarder). The touch substrate 141 includes polycarbonate (PC). Light incident onto the touch substrate 141 may be transformed into a circularly polarized component rotating in one direction while passing through the touch substrate 141.

The first low refractive layer 145 may be disposed on the touch substrate 141, and the sensing electrodes 142 and 143 may be formed on the first low refractive layer 145. The sensing electrodes 142 and 143 may include a first sensing electrode 142 formed in parallel to a first direction X, and a second sensing electrode 143 formed substantially parallel to a second direction Y crossing the first direction X.

The first sensing electrode 142 may be connected to a first wiring 147. The second sensing electrode 143 may be connected to a second wiring 148. The first and second sensing electrodes 142 and 143 may be formed in a touch area TA. The first and second wirings 147 and 148 may be formed in a peripheral area PA outside the touch area TA.

The first sensing electrode 142 may include first sensing cells 142a having a substantially rhombus shape. The first sensing electrode 142 may include, first connection portions 142b connecting the first sensing cells 142a in the first direction X. The first sensing electrode 142 may be a transmitter (Tx) touch electrode to which a first touch signal for sensing a coordinate value in the second direction Y is transmitted.

The second sensing electrode 143 may include second sensing cells 143a having a substantially rhombus shape. The second sensing electrode 143 may include second connection portions 143b connecting the second sensing cells 143a in the second direction Y. The second sensing electrode 143 may be a receiver (Rx) touch electrode to which a second touch signal for sensing a coordinate value in the first direction X is transmitted. The shapes of the first and second sensing cells 142a and 143a are not limited to the rhombus shape.

The first and second sensing electrodes 142 and 143 may be formed in a mesh shape on the non-pixel area NPX and formed of an opaque conductive layer. The first and second sensing electrodes 142 and 143 may include a low resistance metal such as silver (Ag), aluminum (Al), copper (Cu), chromium (Cr), and nickel (Ni) or include a conductive nano material such as silver (Ag) nanowire and a carbon nanotube (CNT).

The first and second sensing electrodes 142 and 143 include a low resistance metal or a conductive nano material and may have a low resistance to reduce an RC delay. The first and second sensing electrodes 142 and 143 may have excellent flexibility to prevent the display device 100 from cracking even due to repeated deformation such as warping. Further, the first and second sensing electrodes 142 and 143 formed in the mesh shape may not block the light emitted from the pixel and may reduce an area facing the common electrode 127 formed in the display panel 110, thereby minimizing parasitic capacitance.

The first sensing electrode 142 and the second sensing electrode 143 may be formed on the same layer. In this case, the first connection portion 142b and the second connection portion 143b may be in contact with each other to cause a short circuit. For this reason, an insulating layer 149 may be formed between the first connection portion 142b and the second connection portion 143b to prevent the short circuit between the first connection portion 142b and the second connection portion 143b. The insulating layer 149 may be formed to have a larger width than those of the first and second connection portions 142b and 143b at an overlapping portion of the first connection portion 142b and the second connection portion 143b.

The first and second sensing electrode 142 and 143 may be covered with the passivation layer 144 so as not to be exposed to elements outside the display device (e.g., moisture and oxygen). The insulating layer 149 and the passivation layer 144 may include the same material, for example, silicon nitride (SiNₓ). The passivation layer 144 formed of SiNₓ may have a refractive index of about 1.9 to 2.3.

The first low refractive layer 145 may be formed on a lower surface of the passivation layer 144. The second low refractive layer 146 may be formed on an upper surface of the passivation layer 144. The first and second low refractive layers 145 and 146 may have a refractive index lower than the passivation layer 144. The first and second low refractive layers 145 and 146 may improve light transmittance by matching the refractive index of the passivation layer 144. The first and second low refractive layers 145 and 146 may have a refractive index of about 1.6 to about 1.8, and may include any one of silicon oxynitride (SiON) and aluminum oxide (AlOₓ).

The first and second low refractive layers 145 and 146 including silicon oxynitride may be formed by a plasma enhanced chemical vapor deposition. The first and second low refractive layers 145 and 146 including aluminum oxide may be formed by sputtering. Silicon oxynitride and aluminum oxide do not absorb light and have a refractive index of about 1.6 to about 1.8, as described above.

Further, the first low refractive layer 145 disposed between the touch substrate 141 and the passivation layer 144 may prevent damage to the touch substrate 141 caused by an etchant and a stripper when forming the sensing electrodes 142 and 143. The sensing electrodes 142 and 143 may be formed by depositing the entire surface of the conductive layer and through photolithography processes. Etchants are used in the photolithography process to for remove the conductive layer and strippers are used for remove a photoresist.

When the first low refractive layer 145 is not provided, the touch substrate 141 may be directly exposed to the etchant and the stripper when forming the sensing electrodes 142 and 143 by patterning the conductive layer. Because the touch substrate 141 includes a polymer material, the touch substrate 141 is vulnerable to the etchant and the stripper causing the touch substrate 141 to be damaged during the photolithography process. The damage to the touch substrate 141 leads to a pattern defect, such as a pattern loss and a short circuit, of the sensing electrodes 142 and 143.

The first low refractive layer 145, which is an inorganic layer, is hardly damaged from the etchant and the stripper. Therefore, the display device 100 may prevent damage to the touch substrate 141 by using the first low refractive layer 145 and further prevent a pattern defect, such as a pattern loss and a short circuit, of the sensing electrodes 142 and 143.

The following table shows light transmittance of touch sensors according to Examples 1, 2, and 3 and light transmittance of touch sensors according to Comparative Examples 1 and 2. The light transmittance is divided into light transmittance representing the experimental results at three wavelengths (450 nm, 550 nm, and 650 nm), and an average transmittance of the transmittance at the three wavelengths.

TABLE 1

Light transmittance (%)

| | | | | Average |
|---|---|---|---|---|
| | 450 nm | 550 nm | 650 nm | transmittance |
| Comparative | 75.9 | 85.1 | 71.1 | 83.1 |
| Example 1 | | | | |
| Example 1 | 93.2 | 88.0 | 85.4 | 88.6 |
| Example 2 | 91.8 | 85.7 | 89.3 | 88.5 |
| Example 3 | 89.3 | 93.9 | 92.7 | 88.2 |
| Comparative | 85.3 | 78.2 | 84.0 | 82.5 |
| Example 2 | | | | |

A touch sensor of Comparative Example 1 includes a polycarbonate film as the touch substrate, a metal mesh as the sensing electrode, and silicon nitride as the passivation layer with a thickness of 4000 Å. A touch sensor of Comparative Example 2 includes a polycarbonate film as the touch substrate, a silver nanowire mesh as the sensing electrode, and silicon nitride as the passivation layer with a thickness of 2000 Å.

Touch sensors of Examples 1, 2, and 3 each include a polycarbonate film as the touch substrate, silicon oxynitride as the first low refractive layer at a thickness of 900 Å, a metal mesh as the sensing electrode, silicon nitride as the passivation layer at a thickness of 4000 Å, and silicon oxynitride as the second low refractive layer. The second low refractive layers have thicknesses of 800 Å, 900 Å, and 1000 Å in Examples 1, 2, and 3, respectively.

In Examples 1, 2, and 3, the first and second low refractive layers 145 and 146 have refractive indexes less than that of the passivation layer 144. Thus, when light emitted from the pixel PX of the display panel 110 penetrates the touch sensor 140, the reflection of light, which occurs at an interlayer interface, is reduced resulting in an increase in light transmittance of the touch sensor 140. It can be seen from the result of Table 1 that the touch sensors 140 of Examples 1, 2, and 3 implement higher light transmittance than the touch sensors of Comparative Examples 1 and 2.

Each of the first and second low refractive layers 145 and 146 may be formed to have a thickness of about 900 Å to about 1500 Å. When the thickness of the first low refractive layer 145 is less than about 900 Å, the touch substrate 141 may suffer more from external impact, scratches, and the like than the thickness of the first low refractive layer 145 is about 900 Å to about 1500 Å. In other words, when the first low refractive layer 145 is excessively thin, the first low refractive layer fails to protect the touch substrate 141. When the thicknesses of both the first and second low refractive layers 145 and 146 are less than about 900 Å, the display device 100 may not have an improved light transmittance, or the light transmittance is only marginally improved as compared to a device without the first and second low refractive layers 145 and 146. When thicknesses of the first and second low refractive layers 145 and 146 are greater than 1500 Å, the display device may become excessively rigid because the touch sensor 140 becomes excessively rigid.

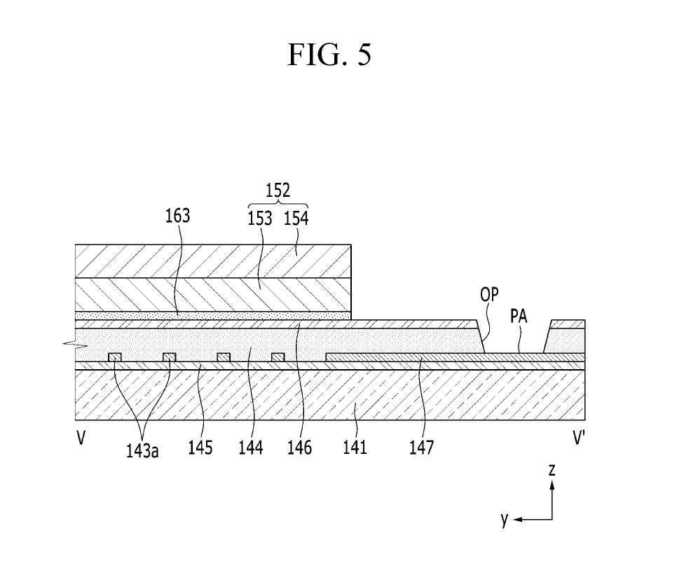

FIG. 5 is an enlarged cross-sectional view of the display device taken along sectional line V-V′ of FIG. 1.

Referring to FIG. 1 and FIG. 5, the first and second wirings 147 and 148 may be connected to a pad portion PA formed at an edge of the touch substrate 141. The pad portion PA may be connected to a circuit board 180 for use as a touch sensor. The sensing electrodes 142 and 143 may receive a touch signal from the circuit board 180 for a touch sensor through the pad portion PA and the first and second wirings 147 and 148.

The first low refractive layer 145, the passivation layer 144, and the second low refractive layer 146 may be formed to have the same size as the touch substrate 141. The passivation layer 144 and the second low refractive layer 146 may be provided with an opening OP through which the pad portion PA is exposed. The circuit board 180 for a touch sensor may be connected to the exposed pad portion PA. An anisotropic conductive film may be used to attach the circuit board 180 for a touch sensor onto the pad portion PA.

The passivation layer 144 and the second low refractive layer 146 may cover all of the sensing electrodes 142 and 143 and all of the first and second wirings 147 and 148 except for the pad portion PA. Accordingly, the touch sensor 140 may suppress moisture from permeating into the sensing electrodes 142 and 143 and the wirings 147 and 148 and suppress a wiring defect due to moisture permeation, thereby improving reliability of a product.

Referring to FIGS. 1 to 3, the polarization film 150 may improve visibility of a screen by suppressing reflection of external light of the display device 100. The polarization film 150 may includes the circular polarizer (touch substrate) 141 and a linear polarizer 152.

The linear polarizer 152 may include a polarizer 153 stretched in one direction and a protective film 154 protecting the polarizer 153. For example, the polarizer 153 may be a polyvinyl alcohol (PVA) film and the protective film 154 may be a tri-acetyl cellulose (TAC) film. The linear polarizer 152 may be attached to the touch sensor 140 by a third adhesive layer 163.

The polarization film 150 integrated with the touch sensor 140 may be formed in a stacking structure of the circular polarizer (touch substrate) 141, the first low refractive layer 145, the sensing electrodes 142 and 143, the insulating layer 149, the passivation layer 144, the second low refractive layer 146, the third adhesive layer 163, the polarizer 153, and the protective film 154. The touch sensor 140 may not include a self-substrate, and may use the circular polarizer as the touch substrate 141, thereby reducing the total thickness of the display device 100.

When external light is incident to the display device 100, a component of the incident external light, which oscillates in a direction parallel to a transmissive axis of the linear polarizer 152, penetrates the linear polarizer 152. Thus, the transmitted component is transformed into circularly polarized light rotating in one direction while passing through the circular polarizer 141.

The circularly polarized light becomes circularly polarized light rotating in an opposite direction by being reflected by a metal layer (e.g., pixel electrode) of the display panel 110, and is transformed into linearly polarized light while passing through the circular polarizer 141. In this case, the oscillating direction of the linearly polarized light is orthogonal to the transmissive axis of the linear polarizer 152, so that the linearly polarized light cannot penetrate the linear polarizer 152. The polarization film 150 may minimize the reflection of external light and may improve outdoor visibility of the display device.

In the above-described touch sensor 140, the first low refractive layer 145 and the second low refractive layer 146 may have the same refractive index or different refractive indexes. When the first low refractive layer 145 and the second low refractive layer 146 have different refractive indexes, the first low refractive layer 145 is in contact with the touch substrate 141 so as to have an optimal refractive index by matching the refractive index of the first low refractive layer 145 with refractive indexes of the touch substrate 141 and the passivation layer 144. The second low refractive layer 146 is in contact with the third adhesive layer 163 so as to have an optimal refractive index by matching the refractive index of second low refractive layer 146 with refractive indexes of the passivation layer 144 and the third adhesive layer 163.

When the touch substrate 141 is a polycarbonate film, the passivation layer 144 may include silicon nitride, and the first and second low refractive layers 145 and 146 may include silicon oxynitride. In this case, the optimal refractive index of the first low refractive layer 145 may be in a range of about 1.7 to about 1.8. In addition, the optimal refractive index of the second low refractive layer 146 may be in a range of about 1.6 to about 1.75.

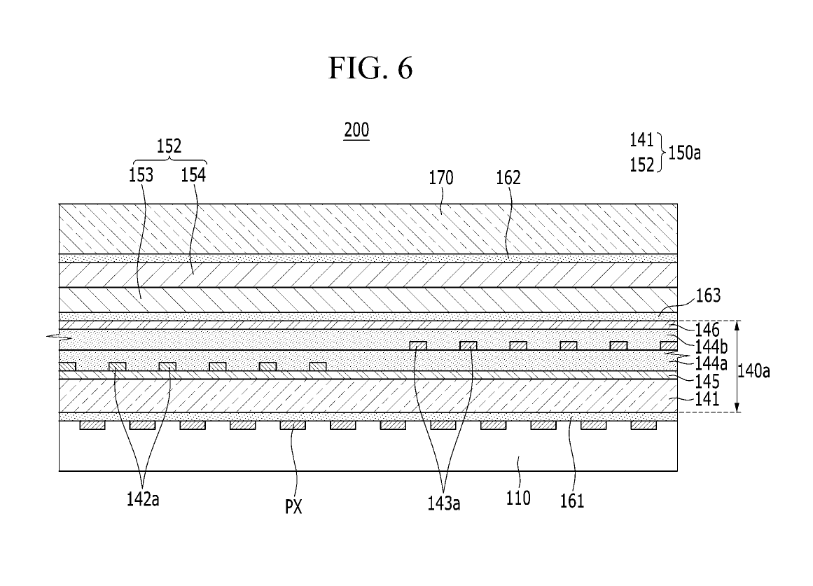

FIG. 6 is a cross-sectional view illustrating a display device according to an exemplary embodiment.

Referring to FIG. 6, a display device 200 may include a first sensing electrode 142 and a second sensing electrode 143 formed on different layers. The display device may also include a passivation layer 144 that includes a first passivation layer 144a and a second passivation layer 144b.

The first sensing electrode 142 may be formed on a first low refractive layer 145. The first passivation layer 144a may cover the first sensing electrode 142. The second sensing electrode 143 may be formed on the first passivation layer 144a. The second passivation layer 144b may cover the second sensing electrode 143. The first and second passivation layers 144a and 144b may include silicon nitride.

Positions of the first and second sensing electrodes 142 and 143 are not limited to the illustrated example. For example, the first sensing electrode 142 may be disposed where the second sensing electrode 143 is illustrated, and vice versa.

The first low refractive layer 145 may be formed on a lower surface of the first passivation layer 144a and the second low refractive layer 146 may be formed on an upper surface of the second passivation layer 144b. The first low refractive layer 145, the first passivation layer 144a, the second passivation layer 144b, and the second low refractive layer 146 may be formed to have the same size as the touch substrate 141. The first passivation layer 144a, the second passivation layer 144b, and the second low refractive layer 146 may be formed with an opening (not illustrated) to expose a pad portion (not illustrated).

The configuration of the display device of FIG. 6 other than the first and second sensing electrodes 142 and 143 and the first and second passivation layers 144a and 144b is the same as that of the exemplary embodiment illustrated in FIG. 2. In FIG. 6, reference numeral 140a represents a touch sensor and reference numeral 150a represents a polarization film.

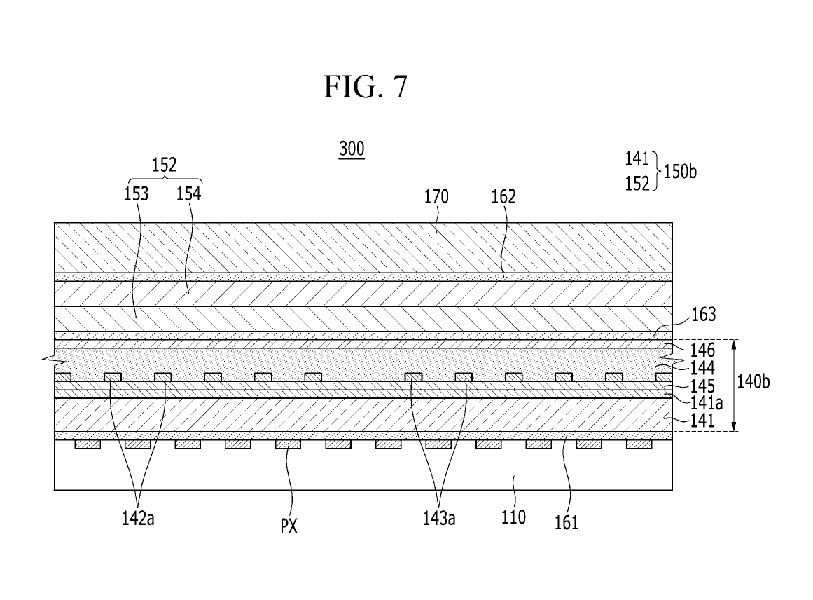

FIG. 7 is a cross-sectional view illustrating a display device according to a third exemplary embodiment.

Referring to FIG. 7, a display device 300 may include a touch sensor 140b that includes a hard coating layer 141a formed between a touch substrate 141 and a first low refractive layer 145. The hard coating layer 141 a may include any one of acrylate, siloxane, and urethane acrylate. The hard coating layer 141 a may be formed to have a thickness that does not degrade flexibility. For example, the hard coating layer 141 a may have a thickness of about 2000 Å or less.

The hard coating layer 141a may protect the surface of the touch substrate 141. Specifically, the hard coating layer 141 a may prevent damage to the touch substrate 141 when the first low refractive layer 145 is formed on the touch substrate 141 by plasma enhanced chemical vapor deposition or sputtering.

In the display device 300, the configuration other than the hard coating layer 141a is the same as that of exemplary embodiment illustrated in FIG. 2 or 6. In FIG. 7, reference numeral 150b represents a polarization film.

In order to implement a flexible display device, there is a need to make the display device thin, and for this purpose, the touch sensor 140, 140a, 140b may be integrated with a polarization film 150, 150a. In this case, the touch sensor 140, 140a, 140b may not include a self-substrate and may have a configuration in which sensing electrodes 142 and 143 are directly formed on any one constituent element of the polarization film 150, 150a.

According to exemplary embodiments, the first low refractive layer 145 and the second low refractive layer 146 may be disposed on the lower surface and the upper surface of the protection layer or passivation layer 144 (including 144a and 144b), respectively, so that it is possible to reduce reflection of light which occurs at an interlayer interface when light emitted from the pixel of the display panel penetrates the touch sensor. Therefore, it is possible to improve luminance of the display device by increasing light transmittance of the touch sensor.

Further, the touch substrate 141may be protected by the first low refractive layer 145 and thus is not exposed to an etchant and a stripper when forming the sensing electrodes 142 and 143, thereby preventing damage to the touch substrate 141 and a pattern defect of the sensing electrode 142 and 143 due to damage to the touch substrate 141 during the process of forming the sensing electrodes 142 and 143.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device, comprising:
a display panel comprising pixels; and
a touch sensor disposed on the display panel,
wherein the touch sensor comprises:
a touch substrate;
sensing electrodes disposed on the touch substrate;
a passivation layer covering the sensing electrodes on the touch substrate; and
a first low refractive layer disposed between the touch substrate and the passivation layer, and having a refractive index lower than a refractive index of the passivation layer.

2. The display device of claim 1, wherein:
the passivation layer includes silicon nitride; and
the first low refractive layer has a refractive index in a range of about 1.6 to about 1.8.

3. The display device of claim 2, wherein the first low refractive layer comprises at least one of silicon oxynitride and aluminum oxide.

4. The display device of claim 1, wherein the touch sensor further comprises a hard coating layer disposed between the touch substrate and the first low refractive layer.

5. The display device of claim 4, wherein:
the hard coating layer comprises at least one of acrylate, siloxane, and urethane acrylate; and
the hard coating layer has a thickness of about 2000 Å or less.

6. The display device of claim 1, wherein:
the touch sensor further comprises a second low refractive layer disposed on an upper surface of the passivation layer; and
the second lower refractive layer has a refractive index lower than a refractive index of the passivation layer.

7. The display device of claim 6, wherein:
the passivation layer comprises silicon nitride; and
the second low refractive layer has a refractive index in a range of about 1.6 to about 1.8.

8. The display device of claim 7, wherein the second low refractive layer comprises at least one of silicon oxynitride and aluminum oxide.

9. The display device of claim 6, wherein each of the first low refractive layer and the second low refractive layer has a thickness in a range of about 900 Å to about 1500 Å.

10. The display device of claim 6, wherein:
each of the sensing electrodes is connected to a pad portion disposed at an edge of the touch substrate through a wiring; and
the passivation layer and the second low refractive layer have the same size as the touch substrate, and comprise an opening to expose the pad portion.

11. The display device of claim 1, wherein the sensing electrodes comprise an opaque conductive layer comprising a mesh shape to correspond to spaces between the pixels.

12. The display device of claim 1, wherein the touch substrate is configured to polarize light.

13. A display device, comprising:
a display panel comprising pixels; and
a touch sensor integrated polarization film disposed on the display panel,
wherein the touch sensor integrated polarization film comprises:
a circular polarizer;
sensing electrodes disposed on the circular polarizer;
a passivation layer covering the sensing electrodes on the circular polarizer;
a first low refractive layer disposed on a lower surface of the passivation layer, the first low refractive layer having a refractive index lower than a refractive index of the passivation layer;
a second low refractive layer disposed on an upper surface of the passivation layer, the second low refractive layer having a refractive index lower than the refractive index of the passivation layer; and
a linear polarizer disposed on the second low refractive layer.

14. The display device of claim 13, wherein:
the passivation layer comprises silicon nitride; and
each of the first low refractive layer and the second low refractive layer has a refractive index in a range of about 1.6 to about 1.8.

15. The display device of claim 14, wherein each of the first low refractive layer and the second low refractive layer comprises at least one of silicon oxynitride and aluminum oxide.

16. The display device of claim 13, further comprising a hard coating layer disposed between the circular polarizer and the first low refractive layer.
